(19) United States
(12) Patent Application Publication
(10) Pub. No.: US 2026/0300196 A1
(43) Pub. Date: Oct. 1, 2026

(54) DEVICES AND METHODS FOR PROCESSING VECTORS IN NEURAL NETWORK COMPUTATION

(71) Applicant: CAMBRICON TECHNOLOGIES CORPORATION LIMITED, Beijing (CN)

(72) Inventors: Yunji CHEN, Beijing (CN); Shaoli LIU, Beijing (CN); Tianshi CHEN, Beijing (CN)

(21) Appl. No.: 19/698,745

(22) Filed: Jun. 4, 2026

Related U.S. Application Data
(63) Continuation-in-part of application No. 16/268,479, filed on Feb. 5, 2019.
Application No. 16/268,479 is a continuation-in-part of application No. PCT/CN2017/093161, filed on Jul. 17, 2017.

(30) Foreign Application Priority Data
Aug. 5, 2016 (CN) 201610640115.6

(51) Int. Cl. G06F 13/20; G06N 3/08

(52) U.S. Cl. CPC G06F 13/20; G06N 3/08; G06F 2213/40

(57) ABSTRACT

An apparatus for neural network processing includes a computation module, a data I/O module, a data buffer unit, and a data adjustment module. The computation module has a processing width corresponding to a count of reference elements. The data I/O module receives from a memory a first vector divided into a plurality of first segments and a second vector. The data buffer unit retains the second vector until the computation module completes operations on all of the plurality of first segments, such that the data I/O module loads the second vector from the memory a single time for the plurality of first segments. For each first segment, the data adjustment module cyclically retrieves elements from the retained second vector, pairs the retrieved elements with the first segment, and transmits the paired first segment and elements to the computation module to perform the operations.

This application is a continuation in Part of U.S. application Ser. No. 16/268,479, filed on Feb. 5, 2019, which is a continuation-in-part of PCT Application No. PCT/CN2017/093161, filed on Jul. 17, 2017, which claims priority to commonly owned Chinese Application No. 201610640115.6 filed on Aug. 5, 2016. Each of the above applications is hereby incorporated by reference in its entirety.

### TECHNICAL FIELD

The present disclosure relates to the field of computing hardware for neural networks, and in particular, to devices and methods for processing vectors in neural network computation.

### BACKGROUND

Multilayer neural networks (MNN) are widely applied to the fields such as pattern recognition, image processing, functional approximation, and optimal computation. In recent years, due to the higher recognition accuracy and better parallelizability, multilayer artificial neural networks have received increasing attention by academic and industrial communities.

In addition, neural network data include data in different formats and of different lengths. Conventionally, a general-purpose processor, e.g., a CPU, or a graphic processing unit may be implemented for neural network processing. However, the conventional devices may be limited to processing data of a single format. The instruction set for the conventional devices may also be limited to processing data of the same length. With respect to data of different lengths, one or more instructions may be executed; alternatively, one instruction may be repetitively executed, which may lead to unnecessarily long instruction queues and may result in lower system efficiency.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One example aspect of the present disclosure provides an example apparatus for processing data segments in neural networks. The example apparatus may include a computation module capable of performing operations between two vectors in accordance with one or more instructions. Each of the two vectors includes at most a count of multiple reference elements. The example apparatus may further include a data input/output (I/O) module configured to receive neural network data formatted in a first vector and a second vector. The first vector may include multiple first elements and the second vector may include multiple second elements. The data I/O module may be further configured to determine that at least one of a count of the first elements or a count of the second elements is greater than the count of the reference elements. The example apparatus may further include a data adjustment module configured to respectively divide the first vector and the second vector into one or more first segments and one or more second segments and transmit the one or more first segments and the one or more second segments to the computation module. The computation module may then be configured to respectively perform the operations between the one or more first segments and the one or more second segments.

Another example aspect of the present disclosure provides an exemplary method for processing data segments in neural networks. The example method may include receiving, by a data I/O module, neural network data formatted in a first vector and a second vector. The first vector may include multiple first elements and the second vector may include multiple second elements. The example method may further include determining, by the data I/O module, that at least one of a count of the first elements or a count of the second elements is greater than a threshold count. Further still, the example method may include respectively dividing, by a data adjustment module, the first vector and the second vector into one or more first segments and one or more second segments. In addition, the example method may include transmitting, by the data adjustment module, the one or more first segments and the one or more second segments to a computation module. The computation module may be capable of performing operations between two vectors in accordance with one or more instructions. Each of the two vectors includes at most a count of multiple reference elements. The count of the reference elements is equal to the threshold count. The example method may further include respectively performing, by the computation module, the operations between the one or more first segments and the one or more second segments.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

A further example aspect of the present disclosure provides an example apparatus for neural network processing. The example apparatus may include a computation module having a processing width corresponding to a count of reference elements, the count of the reference elements being a maximum count of elements that the computation module is capable of processing in a single processing cycle. The example apparatus may further include a data input/output (I/O) module configured to receive, from a memory, a first vector and a second vector, the first vector constituting a longer vector that is divided into a plurality of first segments and the second vector constituting a shorter vector. The example apparatus may further include a data buffer unit configured to receive the second vector from the data I/O module and to retain the second vector within the data buffer unit until the computation module completes operations on all of the plurality of first segments, such that the data I/O module loads the second vector from the memory a single time for the plurality of first segments. The example apparatus may further include a data adjustment module configured to, for each first segment of the plurality of first segments, cyclically retrieve a plurality of elements from the second vector retained in the data buffer unit, pair the plurality of elements that have been cyclically retrieved with the first segment, and transmit the first segment paired with the plurality of elements to the computation module to perform the operations.

A further example aspect of the present disclosure provides an example image processing chip. The example image processing chip may include a convolution module, a convolution output buffer, a neural network acceleration processor, an activation function module, and a pooling module. The neural network acceleration processor may be coupled between the convolution output buffer and the activation function module and may constitute a stage of an inference pipeline of the image processing chip, the neural network acceleration processor including a computation module, a data input/output (I/O) module, and a data buffer unit. The data I/O module may receive, from the convolution output buffer, a convolution output result formatted as a first vector, and may receive a bias vector as a second vector. The data buffer unit may retain the bias vector within the data buffer unit until the computation module completes element-wise addition operations on a plurality of first segments into which the first vector is divided, such that the data I/O module loads the bias vector from a memory a single time for the plurality of first segments. The computation module may, for each first segment of the plurality of first segments, perform one of the element-wise addition operations between the first segment and a plurality of elements cyclically retrieved from the bias vector retained in the data buffer unit to generate a biased intermediate result. The neural network acceleration processor may transmit the biased intermediate result to the activation function module to trigger subsequent operations by the activation function module and the pooling module.

A further example aspect of the present disclosure provides an example large-model inference acceleration circuit. The example large-model inference acceleration circuit may include an attention module, a residual connection module, a root-mean-square calculation module, a neural network acceleration processor, and a linear projection module. The neural network acceleration processor may be coupled between the root-mean-square calculation module and the linear projection module and may constitute a stage of an inference pipeline of the large-model inference acceleration circuit, the neural network acceleration processor including a computation module, a data input/output (I/O) module, and a data buffer unit. The data I/O module may receive, from the root-mean-square calculation module, a normalized hidden-state vector as a first vector, and may receive a learnable scaling factor vector as a second vector. The data buffer unit may retain the learnable scaling factor vector within the data buffer unit until the computation module completes element-wise multiplication operations on a plurality of first segments into which the first vector is divided, such that the data I/O module loads the learnable scaling factor vector from a memory a single time for the plurality of first segments. The computation module may, for each first segment of the plurality of first segments, perform one of the element-wise multiplication operations between the first segment and a plurality of elements cyclically retrieved from the learnable scaling factor vector retained in the data buffer unit to complete a scaling portion of a root-mean-square normalization to generate an output vector of the root-mean-square normalization. The neural network acceleration processor may transmit the output vector to the linear projection module to trigger a linear projection operation on a next layer of a large language model.

### BRIEF DESCRIPTION OF DRAWINGS

The disclosed aspects will hereinafter be described in conjunction with the appended drawings, provided to illustrate and not to limit the disclosed aspects, wherein like designations denote like elements, and in which:

FIG. 1 illustrates a block diagram of an example neural network acceleration processor by which data segmentation may be implemented;

FIG. 2 illustrates a block diagram of an example computation module by which data segmentation may be implemented;

FIG. 3A illustrates a first example operation between data segments;

FIG. 3B illustrates a second example operation between data segments;

FIG. 4 illustrates a flow chart of an example method for processing neural network data;

FIG. 5 illustrates a third example operation between data segments;

FIG. 6 illustrates a fourth example operation between data segments;

FIG. 7 illustrates a fifth example operation between data segments;

FIG. 8 illustrates a block diagram of an example deployment of the apparatus within an image processing chip according to additional embodiments of the present disclosure; and

FIG. 9 illustrates a block diagram of an example deployment of the apparatus within a large-model inference acceleration circuit according to additional embodiments of the present disclosure.

### DESCRIPTION OF EMBODIMENTS

Various aspects are now described with reference to the drawings. In the following description, for purpose of explanation, numerous specific details are set forth in order to provide a thorough understanding of one or more aspects. It may be evident, however, that such aspect(s) may be practiced without these specific details.

In the present disclosure, the term “comprising” and “including” as well as their derivatives mean to contain rather than limit; the term “or,” which is also inclusive, means and/or.

In this specification, the following various embodiments used to illustrate principles of the present disclosure are only for illustrative purpose, and thus should not be understood as limiting the scope of the present disclosure by any means. The following description taken in conjunction with the accompanying drawings is to facilitate a thorough understanding to the illustrative embodiments of the present disclosure defined by the claims and its equivalent. There are specific details in the following description to facilitate understanding. However, these details are only for illustrative purpose. Therefore, persons skilled in the art should understand that various alternation and modification may be made to the embodiments illustrated in this description without going beyond the scope and spirit of the present disclosure. In addition, for clear and concise purpose, some known functionality and structure are not described. Besides, identical reference numbers refer to identical function and operation throughout the accompanying drawings.

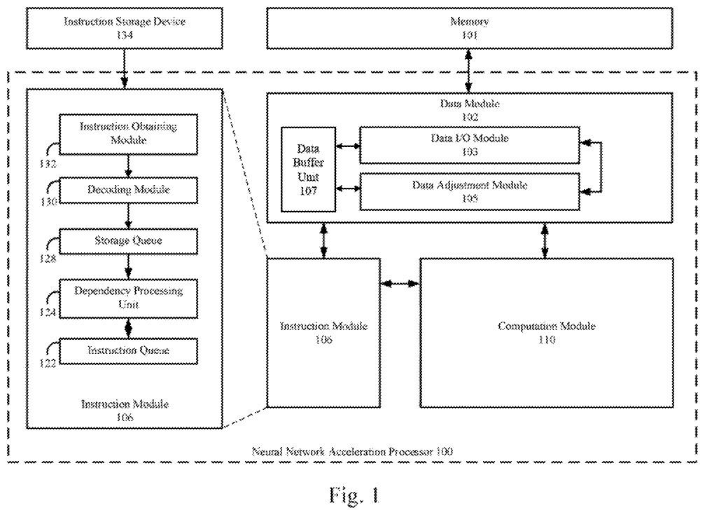

FIG. 1 illustrates a block diagram of an example neural network acceleration processor 100 by which data segmentation may be implemented.

As depicted, the example neural network acceleration processor 100 may include a data module 102, an instruction module 106, and a computation module 110. In general, the data module 102 may be configured to retrieve neural network data from an external storage device, e.g., a memory 101. The instruction module 106 may be configured to receive instructions that specify operations to be performed on the retrieved data from an instruction storage device 134, which may also refer to an external device. Upon receiving instructions from the instruction module 106 and data from the data module 102, the computation module 110 may be configured to process the data in accordance with the received instructions. Any of the above-mentioned components or devices included therein may be implemented by a hardware circuit (e.g., application specific integrated circuit (ASIC), Coarse-grained reconfigurable architectures (CGRAs), field-programmable gate arrays (FPGAs), analog circuits, memristor, etc.).

In more detail, the instruction storage device 134 external to the neural network acceleration processor 100 may be configured to store one or more instructions to process neural network data. The instruction module 106 may include an instruction obtaining module 132 configured to receive one or more instructions from the instruction storage device 134 and transmit the one or more instructions to a decoding module 130.

The decoding module 130 may be configured to decode the one or more instructions respectively into one or more micro-instructions. Each of the one or more instructions may include one or more opcodes that respectively indicate one operation to be performed to a set of neural network data. The decoded instructions may then be temporarily stored by a storage queue 128.

The decoded instructions may then be transmitted from the storage queue 128 to a dependency processing unit 124. The dependency processing unit 124 may be configured to determine whether at least one of the instructions has a dependency relationship with the data of the previous instruction that is being executed. The one or more instructions may be stored in the storage queue 128 until there is no dependency relationship with the data with the previous instruction that has not finished executing. The dependency relationship may refer to a conflict between data blocks that the instructions rely upon. For example, a dependency relationship may exist between two instructions when the two instructions instruct the computation module 110 to perform operations on two overlapping data blocks. If no dependency relationship exists, the decoded instructions may be transmitted to an instruction queue 122 and further delivered to the computation module 110 sequentially.

More specifically, each of the instruction obtaining module 132, the decoding module 130, the instruction queue 122, the dependency processing unit 124, and the storage queue 128 within the instruction module 106 may be implemented by a hardware circuit including without limitation an application specific integrated circuit (ASIC), a field-programmable gate array (FPGA), a finite-state machine circuit, a programmable logic controller, a register file, or any combination of the foregoing hardware circuits. For example, each of the instruction queue 122 and the storage queue 128 may be implemented by a first-in, first-out (FIFO) buffer circuit including a static random-access memory (SRAM) or a register file; the decoding module 130 may be implemented by a combinational logic circuit or a finite-state machine circuit configured to parse the fields of the hardware instructions; the dependency processing unit 124 may be implemented by a comparator circuit and a register file, the comparator circuit configured to compare operand dependencies of the instruction operations.

In some respects, the data module 102 may be configured to receive neural network data from the memory 101. The neural network data may be in a form of vectors that respectively includes one or more elements. An element hereinafter may refer to a value represented in a predetermined number of bits. For example, a vector may include four elements, e.g., values, each of which may be represented in 16 bits. As described previously, the vectors may include different counts of elements. The count of elements included in a vector may be referred to as the length of the vector.

The computation module 110, however, may only be capable of processing vectors that include at most a predetermined count of elements (referred to as “reference elements” hereinafter). In some examples, the computation module 110 may be capable of performing addition operations between vectors that include at most four elements. As such, the data module 102 may be first configured to determine whether the received vectors include more elements than the computation module 110 can process, e.g., the count of the reference elements. If the elements included in the vectors do not exceed the predetermined count of reference elements that the computation module 110 can process, the vectors may be transmitted by the data module 102 to the computation module 110 directly for further processing. If the data module 102 determines that at least one of the vectors include more elements than the reference elements, the data module 102 may be configured to divide the at least one vectors into shorter segments. Each of the segments may include elements less than or equal to the reference elements. The segments may be transmitted to the computation module 110 in pairs sequentially.

In more detail, the data module 102 may include a data I/O module 103 and a data adjustment module 105. The data I/O module 103 may be configured to receive the first vector and the second vector from the memory 101. The data I/O module 103 may be further configured to determine whether the first vector or the second vector, or both, includes more elements than the reference elements. The data adjustment module 105 may be configured to temporarily store the first vector and the second vector. Further, the data adjustment module 105 may be configured to divide the vector, which includes more elements than the reference elements, into one or more segments.

For example, the computation module 110 may be capable of performing operations between two vectors that each includes at most four elements. The received first vector may include three elements, e.g., A1, A2, and A3. The received second vector may include two elements, e.g., B1 and B2. Since both the first vector and the second vector include elements that are less than the count of the reference elements, the first vector and the second vector may be transmitted to the computation module 110 directly for processing.

In an example where the data I/O module 103 receives a first vector that includes five elements (e.g., A1, A2, A3, A4, and A5) and a second vector that also includes five elements (e.g., B1, B2, B3, B4, and B5), the data adjustment module 105 may be configured to divide the first vector into a first segment D1 (e.g., A1, A2, A3, and A4) and a second segment D2 (e.g., A5), and to divide the second vector into a third segment D3 (e.g., B1, B2, B3, and B4) and a fourth segment D4 (e.g., B5). The segments may be transmitted in pairs to the computation module 110. For example, the first segment D1 and the third segment D3 may be first transmitted to the computation module 110, followed by the second segment D2 and the fourth segment D4.

In some other examples, the elements in a segment may be determined in other ways, e.g., by a system administrator, as long as the elements in each segment are less than the count of the reference elements. For example, the first segment may include three elements (e.g., A1, A2, and A3) and the second segment may include two elements (e.g., A4 and A5).

In another example where the first vector includes multiple elements and can be divided into three segments (e.g., D1, D2, and D3) and the second vector can be divided into two segments (e.g., D4 and D5), the segments may be transmitted in three pairs to the computation module 110. For example, segments D1 and D4, D2 and D5, and D3 and D4 may be sequentially transmitted in pairs to the computation module 110.

In sum, when both the first vector and the second vector may be divided into segments, if the count of segments of the first vector is equal to the count of segments of the second vector, the segments of the first vector and the segments of the second vector may be paired correspondingly based on the positions of the segments in the first vector and the second vector. If the count of segments of one vector is greater than the count of segments of another vector, the vector that includes more segments may be referred to as “the longer vector” and the vector that includes fewer segments may be referred to as “the shorter vector.” The segments of the longer vector may be sequentially retrieved, and the segments of the shorter vector may be cyclically retrieved to be paired with the segments of the longer vector.

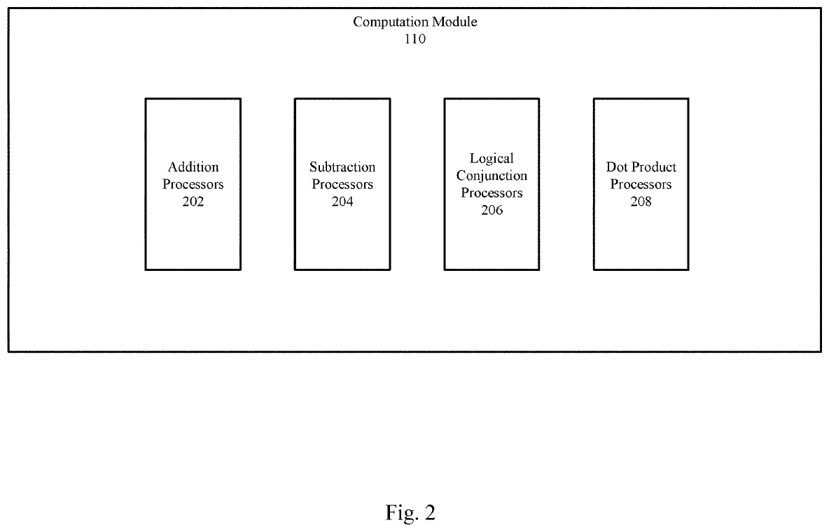

FIG. 2 illustrates a block diagram of an example computation module 110 by which data segmentation may be implemented.

As depicted, the computation module 110 may include one or more addition processors 202, one or more subtraction processors 204, one or more logical conjunction processors 206, and one or more dot product processors 208. The addition processors 202 may be configured to add two vectors respectively to generate a sum vector. The subtraction processors 204 may be configured to subtract one vector from another vector respectively to generate a difference vector. The logical conjunction processors 206 may be configured to perform logical conjunction operations between two vectors. The dot product processors 208 may be configured to calculate a dot product between two vectors.

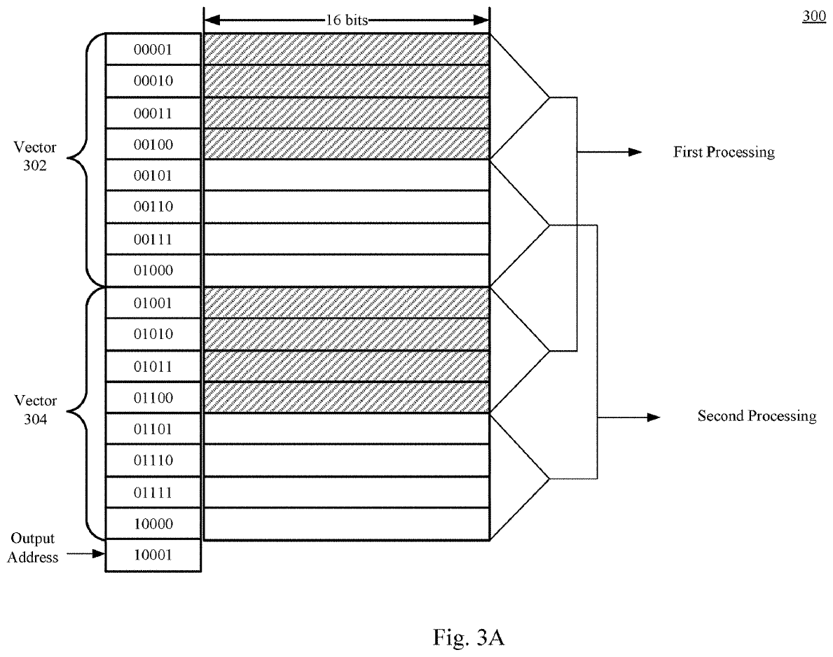

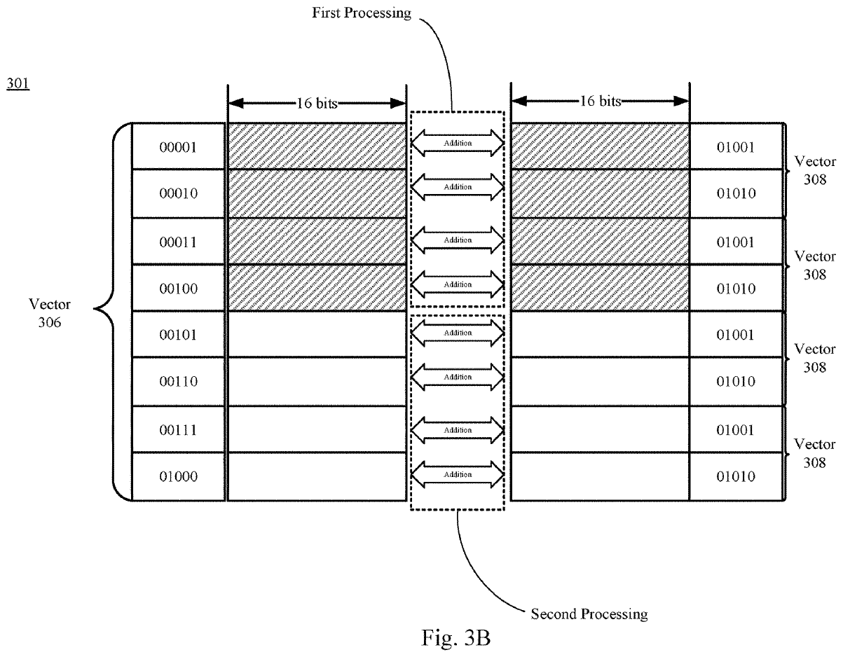

FIG. 3A illustrates an example operation 300 between data segments. The example operation 300 may be initiated in response to a vector-AND-vector (VAV) instruction that instructs the computation module 110 to perform logical conjunction operations between two vectors. The VAV instruction may be formatted as follows:

TABLE 1

| Opcode | Field 1 | Field 2 | Field 3 | Field 4 | Field 5 |
|---|---|---|---|---|---|
| VAV | The starting | Length of | The starting | Length of | Output |
| | address of a | the first | address of a | the second | address |
| | first vector | vector | second vector | vector | |

That is, the VAV instruction may include an opco e that indicates the operation to be performed by the computation module 110, a first field that indicates a starting address of a first vector, a second field that indicates a length of the first vector, a third field that indicates a starting address of a second vector, a fourth field that indicates a length of the second vector, and an output address.

In some examples, the instruction obtaining module 132 may be configured to receive the VAV instruction from the instruction storage device 134. The VAV instruction may be further transmitted to the decoding module 130. The decoding module 130 may be configured to decode the VAV instruction to determine the opcode and the fields in the VAV instruction. For example, a non-limiting example of the VAV instruction may be VAV 00001 01000 01001 01000 10001. The decoded VAV instruction may be transmitted to the storage queue 128.

While the decoded VAV instruction is temporarily stored in the storage queue 128, the data I/O module 103 may be configured to retrieve data based on the fields in the VAV instruction. For example, the data I/O module 103 may retrieve the data stored in 8 addresses from the starting address 00001 as the data of vector 302 and the data stored in another 8 addresses from the starting address 01001 as the data of vector 304.

Based on the retrieved data, the dependency processing unit 124 may be configured to determine whether the VAV instruction and a previously received instruction have a dependency relationship. If not, the VAV instruction may be transmitted to the computation module 110.

The data I/O module 103 may be configured to store the retrieved data in the data adjustment module 105. The data adjustment module 105 may be configured to divide the retrieved data into segments based on the capability of the computation module 110. In some examples, the computation module 110 may include four logical conjunction processors 206. Each logical conjunction processor may be capable of performing logical conjunction operations between two blocks of 16 bits data.

As such, the data adjustment module 105 may be configured to divide the vector 302 and the vector 304 respectively into two segments. Each segment includes four data blocks of 16 bits.

In more detail, the first segment of vector 302, e.g., from address 00001 to address 00100, and the first segment of vector 304, e.g., from address 01001 to address 01100, may be first transmitted to the logical conjunction processors 206. When the logical conjunction processors 206 generate the results between the segments, the data adjustment module 105 may be configured to transmit the second segment of vector 302, e.g., from address 00101 to address 01000, and the second segment of vector 304, e.g., from address 01101 to address 10000, to the logical conjunction processors 206. The results may be transmitted and stored in the output address specified in the VAV instruction, e.g., address 10001.

FIG. 3B illustrates another example operation 301 between data segments. The example operation 301 may be initiated in response to a vector-addition (VA) instruction that instructs the computation module 110 to perform addition operations between two vectors. The VA instruction may be formatted as follows:

TABLE 2

| Opcode | Field 1 | Field 2 | Field 3 | Field 4 | Field 5 |
|---|---|---|---|---|---|
| VA | The starting | Length of | The starting | Length of | Output |
| | address of a | the first | address of a | the second | address |
| | first vector | vector | second vector | vector | |

That is, the V instruction may include an opco e that indicates the operation to be performed by the computation module 110, a first field that indicates a starting address of a first vector, a second field that indicates a length of the first vector, a third field that indicates a starting address of a second vector, a fourth field that indicates a length of the second vector, and an output address.

In some examples, the instruction obtaining module 132 may be configured to receive the VA instruction from the instruction storage device 134. The VA instruction may be further transmitted to the decoding module 130. The decoding module 130 may be configured to decode the VA instruction to determine the opcode and the fields in the VA instruction. For example, a non-limiting example of the VA instruction may be VA 00001 01000 01001 00010 10001. The decoded VA instruction may be transmitted to the storage queue 128.

While the decoded VA instruction is temporarily stored in the storage queue 128, the data I/O module 103 may be configured to retrieve data based on the fields in the VA instruction. For example, the data I/O module 103 may retrieve the data stored in 8 addresses from the starting address 00001 as the data of vector 306 and the data stored in another 2 addresses from the starting address 01001 as the data of vector 308.

Based on the retrieved data, the dependency processing unit 124 may be configured to determine whether the VA instruction and a previously received instruction have a dependency relationship. If not, the VA instruction may be transmitted to the computation module 110.

The data I/O module 103 may be configured to store the retrieved data in the data adjustment module 105. The data adjustment module 105 may be configured to divide the retrieved data into segments based on the capability of the computation module 110. In some examples, the computation module 110 may include four addition processors 202. Each addition processor may be capable of performing addition operations between two blocks of 16 bits data.

Since the vector 306 includes more elements than the reference elements and the vector 308 includes fewer elements than the reference elements, the data adjustment module 105 may be configured to divide vector 306 into two segments. Thus, the first segment of vector 306, e.g., from address 00001 to address 00100, and the vector 308 may be transmitted to the addition processors 202.

The addition processors 202 may be configured to add the first segment of vector 306 to the vector 308. As the vector 308 only includes two data blocks of 16 bits, the addition processors 202 may be configured to duplicate the vector 308 such that the two vectors are aligned.

Similarly, after the addition results between the first segment of vector 306 and vector 308 are generated, the data adjustment module 105 may be configured to transmit the second segment of vector 306, e.g., from address 00110 to address 01000, and the vector 308 to the addition processors 202. The addition processors 202 may be configured to duplicate vector 308 and respectively add the data blocks together.

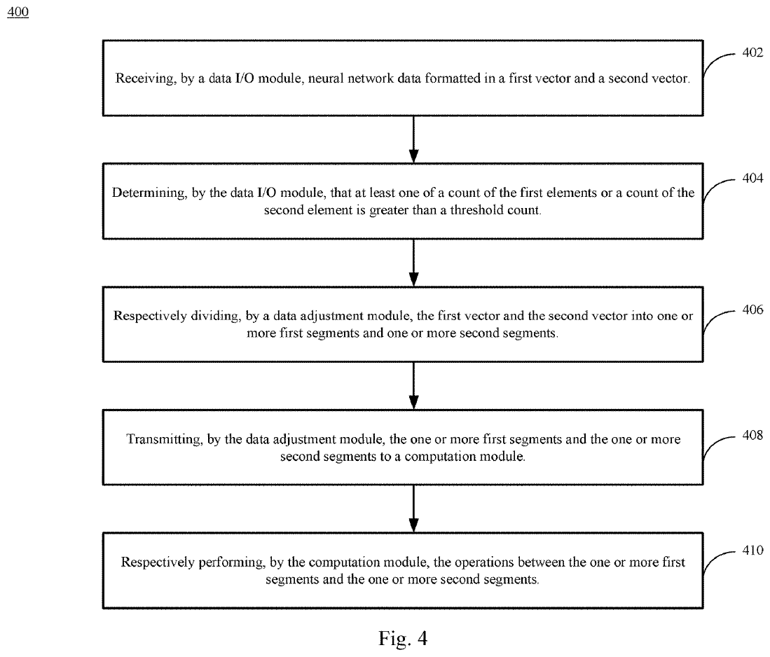

FIG. 4 illustrates a flow chart of an example method 400 for processing neural network data. The example method 400 may be performed by one or more components of the apparatus of FIGS. 1 and 2.

At block 402, the example method may include receiving, by a data I/O module, neural network data formatted in a first vector and a second vector. For example, the data I/O module 103 may be configured to receive a first vector and a second vector from the memory 101. The first vector may include one or more first elements and the second vector may include one or more second elements. Each element may refer to a data block stored in an address.

At block 404, the example method may include determining, by the data I/O module, that at least one of a count of the first elements or a count of the second elements is greater than a threshold count. The threshold count may refer to a maximum number of reference elements that the computation module 110 can process. For example, the data I/O module 103 may be configured to determine if the first vector or the second vector, or both, includes more elements than the reference elements. For example, the first vector may include eight elements referring to data stored in eight addresses but the computation module 110 can only process operations between four data blocks.

At block 406, the example method may include respectively dividing, by a data adjustment module, the first vector and the second vector into one or more first segments and one or more second segments. For example, the data adjustment module 105 may be configured to divide the vector, which includes more elements than the reference elements, into one or more segments.

At block 408, the example method may include transmitting, by the data adjustment module, the one or more first segments and the one or more second segments to a computation module. For example, when both the first vector and the second vector may be divided into segments, if the count of segments of the first vector is equal to the count of segments, the segments of the first vector and the segments of the second vector may be paired correspondingly based on the positions of the segments in the first vector and the second vector. If the count of segments of one vector is greater than the count of segments of another vector, the vector that includes more segments may be referred to as “the longer vector” and the vector that includes fewer segments may be referred to as “the shorter vector.” The segments of the longer vector may be sequentially retrieved, and the segments of the shorter vector may be cyclically retrieved to be paired with the segments of the longer vector.

At block 410, the example method may include respectively performing, by the computation module, the operations between the one or more first segments and the one or more second segments. For example, as described in FIG. 3A, the logical conjunction processors 206 may be configured to perform logical conjunction operations between the first segment of vector 302, e.g., from address 00001 to address 00100, and the first segment of vector 304, e.g., from address 01001 to address 01100.

The process or method described in the above accompanying figures can be performed by process logic including hardware (for example, circuit, specific logic etc.), firmware, software (for example, a software being externalized in a non-transitory computer-readable medium), or the combination of the above two. Although the process or method is described above in a certain order, it should be understood that some operations described may also be performed in different orders. In addition, some operations may be executed concurrently rather than in order.

In the above description, each embodiment of the present disclosure is illustrated with reference to certain illustrative embodiments. Apparently, various modifications may be made to each embodiment without going beyond the wider spirit and scope of the present disclosure presented by the affiliated claims. Correspondingly, the description and accompanying figures should be understood as illustration only rather than limitation. It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Additional embodiments of the present disclosure are described below. These additional embodiments include a cyclic-reuse mechanism for a shorter vector, a replication-extension mechanism for a shorter vector, a hardware-level mechanism for generating multiple micro-instructions from a single hardware instruction, a deployment of the neural network acceleration processor within an image processing chip for performing convolution-plus-bias operations, and a deployment of the neural network acceleration processor within a large-model inference acceleration circuit for performing root-mean-square normalization operations. The additional embodiments may be implemented individually or in any combination thereof. The additional embodiments specify concrete improvements to the functioning of the computer system provided by the neural network acceleration processor, including a reduction in the number of hardware instructions received by the instruction obtaining circuit, a reduction in the number of accesses by the data I/O circuit to the memory, and an increase in the hardware utilization of the computation circuit.

An example cyclic reuse mechanism for the shorter vector according to additional embodiments of the present disclosure will be described below.

In some exemplary embodiments, the data module 102 further includes a data buffer unit 107. The data buffer unit 107 is configured to temporarily store the first vector and the second vector received by the data I/O module 103 from the memory 101, to retain a copy of a shorter vector during cyclic retrieval, and to hold an extended second vector formed by replicating and concatenating the shorter vector.

In some exemplary embodiments, the data buffer unit 107 is implemented as an independent unit within the data module 102, separate from the data adjustment module 105 and coexisting with the data adjustment module 105 within the data module 102. In such embodiments, the data buffer unit 107 is communicatively coupled to the data I/O module 103 and transmits data to and receives data from the data I/O module 103, and the data buffer unit 107 is communicatively coupled to the data adjustment module 105 and transmits data to and receives data from the data adjustment module 105. The data I/O module 103 transmits the first vector and the second vector received from the memory 101 to the data buffer unit 107, the data buffer unit 107 holds the first vector, the second vector, the retained copy of the shorter vector, and/or the extended second vector, and the data adjustment module 105 retrieves vectors or segments thereof from the data buffer unit 107 for pairing and transmission to the computation module 110.

In some other exemplary embodiments, the data buffer unit 107 is integrated within the data adjustment module 105 as an internal portion of the data adjustment module 105. In such embodiments, the data buffer unit 107 may further be a temporary-storage space within the data adjustment module 105 in which the first vector, the second vector, the retained copy of the shorter vector, and/or the extended second vector is held.

The data buffer unit 107 may be implemented by an on-chip memory circuit located on a same integrated circuit die as the computation module 110, including without limitation a static random-access memory (SRAM), an embedded dynamic random-access memory (eDRAM), a register file, a scratchpad memory, a three-dimensional dynamic random-access memory (3D-DRAM), a memristor-based memory, or a non-volatile memory. In some exemplary embodiments, the data buffer unit 107 has a lower access latency than the memory 101.

In some exemplary embodiments, the data I/O module 103 receives neural network data formatted in a first vector and a second vector. The first vector includes a count of first elements that is greater than a count of reference elements, and the second vector includes a count of second elements that is not greater than the count of the reference elements. The count of the reference elements corresponds to a processing width of the computation module 110, that is, a maximum number of elements that the computation module 110 is able to process in a single processing cycle. Because the count of the first elements is greater than the count of the reference elements, the first vector constitutes a longer vector and is divided into a plurality of first segments, and the second vector constitutes a shorter vector.

In some exemplary embodiments, the data I/O module 103 loads all of the second elements of the second vector from the memory 101 one time, and transmits the loaded second vector to the data buffer unit 107. The data buffer unit 107 retains a copy of the loaded second vector within the data buffer unit 107 until the computation module 110 completes performing the operations on all of the plurality of first segments. While the computation module 110 performs the operations on each first segment of the plurality of first segments, the data adjustment module 105 cyclically retrieves the second elements from the copy of the second vector retained in the data buffer unit 107, pairs the cyclically retrieved second elements with the first segment, and transmits the paired first segment and second elements to the computation module 110. The computation module 110 sequentially performs the operations between each first segment of the plurality of first segments and the cyclically retrieved second elements.

For example, in a scenario where the first vector includes 4096 first elements, the second vector includes 32 second elements, and the count of the reference elements is 128, the first vector is divided into 4096/128=32 first segments and the second vector constitutes the shorter vector. In some conventional approaches that do not retain the second vector within the data buffer unit 107, the data I/O module 103 re-loads all 32 second elements of the second vector from the memory 101 prior to each performance of the operations on one of the first segments, and the total number of times that the data I/O module 103 loads the second elements of the second vector from the memory 101 equals 32. In some exemplary embodiments of the present disclosure, by contrast, all 32 second elements of the second vector are loaded only once into the data buffer unit 107, and the total number of times that the data I/O module 103 loads the second elements of the second vector from the memory 101 is reduced from 32 to 1. In at least one exemplary embodiment, the reduction in the total number of times the data I/O module 103 loads the second elements of the second vector from the memory 101 may reduce the total volume of data transfer between the neural network acceleration processor 100 and the memory 101, and may thereby reduce the energy consumed by the data transfer during the performance of the operations. In at least one exemplary embodiment, the cyclic retrieval of the second elements from the copy of the second vector retained in the data buffer unit 107 is performed without padding the second vector with zero values.

In some exemplary embodiments, in a scenario where the count of the first elements is not greater than the count of the reference elements and the count of the second elements is greater than the count of the reference elements, the second vector constitutes the longer vector and the first vector constitutes the shorter vector, and the cyclic reuse mechanism is applied to the first vector in a corresponding manner.

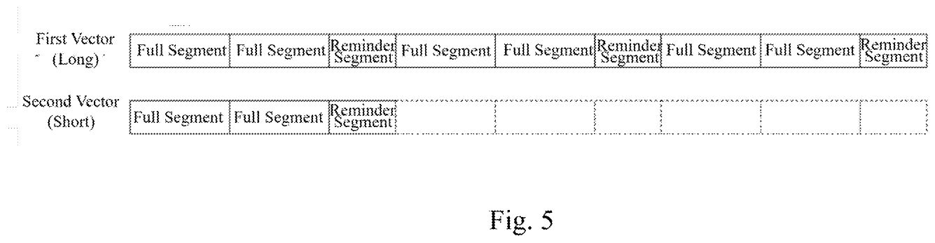

FIG. 5 illustrates a third example operation between data segments. In some exemplary embodiments, if a total length of the second vector (i.e., the count of the second elements) is greater than a processing width (i.e., the count of the reference elements), both the first vector and the second vector are divided. The second vector is divided, according to the processing width, into a plurality of full segments and one remainder segment, a length of each full segment of the second vector being equal to the processing width, and the remainder segment of the second vector being shorter than the processing width. The first vector is correspondingly divided, according to the processing width, into a plurality of full segments and a plurality of remainder segments, a length of each full segment of the first vector being equal to the processing width, and each remainder segment of the first vector being shorter than the processing width. Each full segment of the first vector corresponds to one full segment of the second vector, and each remainder segment of the first vector aligns with the remainder segment of the second vector. The data buffer unit 107 retains the full segments and the remainder segment of the second vector within the data buffer unit 107. The data adjustment module 105 retrieves the full segments and the remainder segment of the second vector from the data buffer unit 107, pairs each full segment of the first vector with a corresponding full segment of the second vector, pairs each remainder segment of the first vector with the remainder segment of the second vector, and transmits the paired segments to the computation module 110. The data adjustment module 105 causes the full segments and the remainder segment of the second vector to be cyclically reused within the data buffer unit 107 to sequentially pair with the plurality of full segments and the plurality of remainder segments of the first vector, until all segments of the first vector have been processed by the computation module 110.

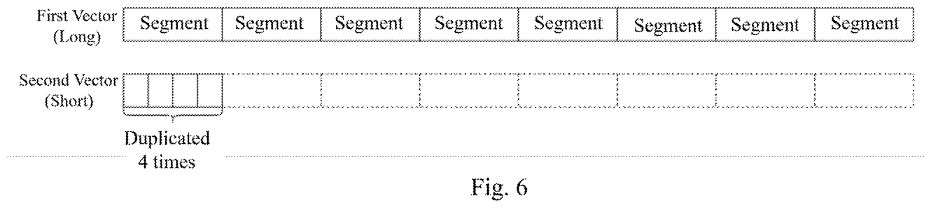

FIG. 6 illustrates a fourth example operation between data segments. The length of each full segment is equal to the count of the parallel processing lanes physically arranged in the computation module 110, such that the computation module 110 processes all elements of one full segment in parallel within a single processing cycle.

For example, in a scenario where the second vector includes 320 second elements and the count of the reference elements is 128, the second vector is divided into 320-128=2 full segments (each full segment including 128 second elements) and one remainder segment (the remainder segment including 320-2×128=64 second elements). The first vector is correspondingly divided according to the same processing width into a plurality of full segments and a plurality of remainder segments, with a division pattern of the first vector being: [full segment][full segment][remainder segment][full segment][full segment][remainder segment] . . . , corresponding to the full segment full segment remainder segment sequence of the second vector. The full segments and the remainder segment of the second vector are loaded only once into the data buffer unit 107, and are cyclically reused during processing of the plurality of full segments and remainder segments of the first vector by the computation module 110.

An example replication-extension mechanism for a shorter vector according to additional embodiments of the present disclosure will be described below.

In some exemplary embodiments, in addition to retaining the second vector within the data buffer unit 107 for cyclic retrieval, the data buffer unit 107 is further configured to perform a replication-extension operation on the second vector as a further optimization. In a scenario where the second vector constitutes a shorter vector and a length of the second vector is substantially smaller than the count of the reference elements (i.e., a processing width of the computation module 110), the data buffer unit 107 replicates the second vector at least one time within the data buffer unit 107, and concatenates the second vector and the replicated at least one second vector within the data buffer unit 107 into an extended second vector. The count of elements in the extended second vector does not exceed the count of the reference elements. The length of the second vector being substantially smaller than the count of the reference elements refers to: the count of the second elements of the second vector being less than one of 50%, 60%, 70%, 80%, or 90% of the count of the reference elements. When the count of the second elements is less than 50% of the count of the reference elements, the second vector is able to be replicated at least one time within the data buffer unit 107 such that the replicated second vectors can be concatenated into the extended second vector having a count of elements closer to the count of the reference elements.

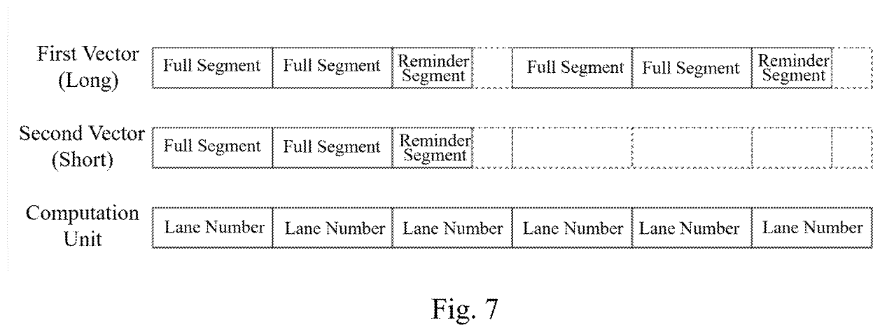

FIG. 7 illustrates a fifth example operation between data segments. For example, in a scenario where the count of the reference elements is 128 and “substantially smaller” is defined as being less than 50% of the count of the reference elements (i.e., 64): (i) when the second vector includes 32 second elements, the count of the second elements (32) is less than 64, and the data buffer unit 107 replicates the second vector three times within the data buffer unit 107 and concatenates the original second vector with the three replicated second vectors within the data buffer unit 107 into the extended second vector that includes 128 elements; and (ii) when the second vector includes 16 second elements, the data buffer unit 107 replicates the second vector seven times within the data buffer unit 107 and concatenates the replicated second vectors within the data buffer unit 107 into the extended second vector that includes 128 elements.

In some exemplary embodiments, the data adjustment module 105 retrieves the extended second vector from the data buffer unit 107, pairs the extended second vector with each first segment of a plurality of first segments of a first vector, and transmits the paired extended second vector and the first segment to the computation module 110. The computation module 110, within a single parallel processing cycle, performs the operations between all of the elements of the extended second vector and all of the elements of the first segment in parallel, and generates an operation result that includes a same count of result elements as the count of the reference elements. A specific increase in the hardware utilization of the computation module 110 provided by the replication-extension mechanism is further illustrated in connection with the deployment within the image processing chip 800 described later.

An example mechanism for generating multiple micro-instructions from a single hardware instruction according to additional embodiments of the present disclosure will be described below.

In some exemplary embodiments, a hardware instruction for processing the first vector and the second vector includes an opcode, a field that indicates a starting address of the first vector, a field that indicates a length of the first vector, a field that indicates a starting address of the second vector, a field that indicates a length of the second vector, an output address, and a short-vector identifier field. The short-vector identifier field identifies which one of the first vector and the second vector is to be processed as a shorter vector.

In some exemplary embodiments, the computation module 110 includes a plurality of parallel processing lanes physically arranged in the computation module 110. Each parallel processing lane processes one element in a single processing cycle of the computation module 110. The count of the reference elements is a physical attribute of the computation module 110 and is equal to the number of the parallel processing lanes physically present in the computation module 110. For example, in a scenario where the computation module 110 includes 128 parallel processing lanes, the count of the reference elements is 128, and the computation module 110 processes 128 elements concurrently in a single processing cycle.

In some exemplary embodiments, the instruction obtaining module 132 receives a single hardware instruction from the instruction storage device 134. The decoding module 130 parses the short-vector identifier field, the length field of the first vector, and the length field of the second vector of the single hardware instruction. During an instruction decoding stage and prior to dispatching any micro-instruction to the computation module 110, the decoding module 130 compares the length field of the first vector and the length field of the second vector against the number of the parallel processing lanes of the computation module 110, and based on a result of the comparison, automatically determines a segmentation manner. The segmentation manner includes: in a scenario where the count of the second elements of the second vector is not greater than the count of the reference elements and the count of the first elements of the first vector is greater than the count of the reference elements, dividing the first vector into a plurality of first segments according to the count of the reference elements; and in a scenario where both the count of the first elements of the first vector and the count of the second elements of the second vector are greater than the count of the reference elements, dividing the first vector into a plurality of first segments according to the count of the reference elements and dividing the second vector into a plurality of second segments according to the count of the reference elements.

In some exemplary embodiments, based on the determined segmentation manner, the decoding module 130 generates a sequence of a plurality of micro-instructions. Each micro-instruction in the sequence corresponds to one operation performed by the computation module 110 on one pair of paired segments. The sequence of the plurality of micro-instructions is transmitted to the instruction queue 122, and the instruction queue 122 sequentially transmits the plurality of micro-instructions to the computation module 110.

For example, in a scenario where the first vector includes 4096 first elements, the second vector includes 32 second elements, and the count of the reference elements is 128, the first vector is divided into 32 first segments. In some conventional approaches, an instruction set supports only vector operation instructions whose length is equal to the count of the reference elements. To complete the operations between the first vector and the second vector, a software compiler generates 32 separate conventional instructions, each conventional instruction corresponding to the operation between one first segment and the second vector, and the instruction obtaining module 132 retrieves 32 conventional instructions from the instruction storage device 134. In some exemplary embodiments of the present disclosure, by contrast, the number of hardware instructions retrieved by the instruction obtaining module 132 from the instruction storage device 134 is reduced from 32 to 1, and the sequence of 32 micro-instructions is automatically generated by the decoding module 130 from the single hardware instruction. In at least one exemplary embodiment, the reduction in the number of hardware instructions retrieved by the instruction obtaining module 132 may reduce the number of accesses by the instruction obtaining module 132 to the instruction storage device 134, and may reduce the waiting delay of the hardware instructions in the instruction queue 122.

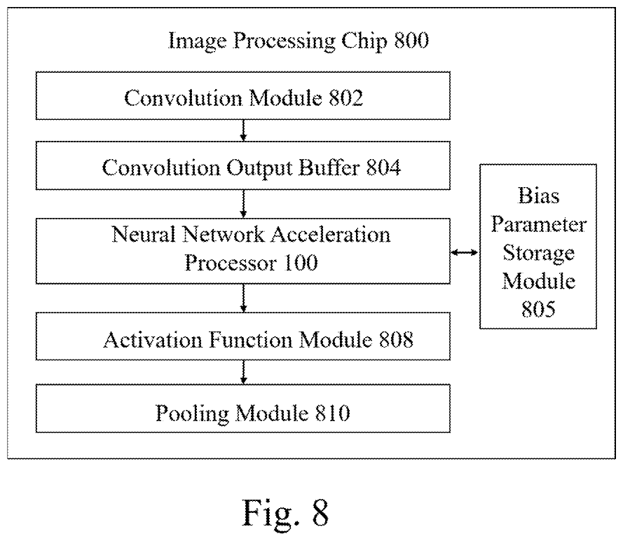

FIG. 8 illustrates a block diagram of an example deployment of the apparatus within an image processing chip for convolution-plus-bias operations according to additional embodiments of the present disclosure.

In some exemplary embodiments, the neural network acceleration processor 100 is deployed within an image processing chip 800. The image processing chip 800 includes at least one of an image signal processor (ISP), a neural network processing unit (NPU), a vision processing unit (VPU), or a neural network acceleration card. The image processing chip 800 is deployed within an imaging device for performing neural network inference. The imaging device includes at least one of a mobile communication device, a surveillance camera device, an in-vehicle image capture device, a medical imaging device, or a portable computing device. In some exemplary embodiments, the neural network acceleration processor 100 is coupled between a convolution output buffer 804 and an activation function module 808 within the image processing chip 800, and constitutes a stage of an inference pipeline of the image processing chip 800.

In some exemplary embodiments, the image processing chip 800 includes a convolution module 802, the convolution output buffer 804, the neural network acceleration processor 100, the activation function module 808, and a pooling module 810. The convolution module 802 performs a convolution operation on an input feature map and transmits an output result of the convolution operation to the convolution output buffer 804. The convolution output buffer 804 temporarily stores the output result of the convolution operation in the form of a first vector, where a count of first elements of the first vector equals a total count of elements across all output positions of all output channels to which the convolution operation is applied.

The image processing chip 800 further comprises a bias parameter storage module 805 communicatively coupled to the data I/O module 103 of the neural network acceleration processor 100. The bias parameter storage module 805 is configured to store the bias vector and to provide the bias vector to the data I/O module 103. The bias parameter storage module 805 stores bias parameters corresponding to the output channels to which the convolution operation is applied. The bias parameter storage module 805 may be implemented by an on-chip memory circuit or an off-chip memory circuit, including without limitation at least one of a static random-access memory (SRAM), an embedded dynamic random-access memory (eDRAM), a register file, a flash memory, an electrically erasable programmable read-only memory (EEPROM), or a memristor-based memory. In some exemplary embodiments, the bias parameter storage module 805 stores the bias parameters that have been trained from a neural network model executed by the image processing chip 800.

In some exemplary embodiments, the data I/O module 103 of the neural network acceleration processor 100 receives the first vector from the convolution output buffer 804, and receives a bias vector from the bias parameter storage module 805 as a second vector, where a count of second elements of the bias vector equals a number of the output channels to which the convolution operation is applied. Because the count of the first elements of the first vector is greater than the count of the reference elements of the computation module 110 and the count of the second elements of the bias vector is not greater than the count of the reference elements, the first vector constitutes a longer vector that is divided into a plurality of first segments, and the bias vector constitutes a shorter vector.

In some exemplary embodiments, the data I/O module 103 loads the second elements of the bias vector one time, and the data adjustment module 105 retains a copy of the bias vector within the data adjustment module 105 until the computation module 110 completes the operations on all of the plurality of first segments. For each first segment of the plurality of first segments, the data adjustment module 105 cyclically retrieves the second elements from the retained copy of the bias vector and pairs the cyclically retrieved second elements with the first segment. The computation module 110 performs an element-wise addition operation between each first segment and the cyclically retrieved second elements of the bias vector, and generates a biased intermediate result.

In some exemplary embodiments, the neural network acceleration processor 100 transmits the biased intermediate result to the activation function module 808, thereby causing the activation function module 808 to perform a non-linear activation operation on the biased intermediate result and generate an activated result. The activation function module 808 transmits the activated result to the pooling module 810, thereby causing the pooling module 810 to perform a pooling operation on the activated result and generate a pooled result as an output of the image processing chip 800.

For example, in an image-plus-bias scenario, the number of the output channels to which the convolution operation is applied is 32, the length of the bias vector (i.e., the count of the second elements) is 32, the length of the flattened feature vector (i.e., the count of the first elements) is 4096, and the count of the reference elements (i.e., the processing width of the computation module 110) is 128. In this scenario, the first vector is divided into 4096+128=32 first segments, and the bias vector constitutes the shorter vector. In some conventional approaches, to complete the convolution-plus-bias operation, a software compiler divides the first vector into 32 segments according to a segment length of 128 and generates 32 separate conventional instructions, each conventional instruction re-loading the bias vector having the 32 second elements and zero-padding the bias vector to 128 elements to align with the processing width of the computation module 110, and the hardware utilization of the computation module 110 during the execution of each conventional instruction is approximately 32+128=25%. In some exemplary embodiments of the present disclosure, by contrast: (i) through the cyclic reuse mechanism, the bias vector having the 32 second elements is loaded only once into the data buffer unit 107, and the total number of times that the data I/O module 103 loads the second elements of the bias vector from the memory 101 is reduced from 32 to 1; (ii) through the replication-extension mechanism, because the count of the second elements of the bias vector (32) is substantially smaller than the count of the reference elements (128), the data buffer unit 107 replicates the bias vector three times within the data buffer unit 107 and concatenates the replicated bias vectors within the data buffer unit 107 into an extended bias vector that includes 128 elements, the extended bias vector occupies all 128 positions of the processing width of the computation module 110 within the single parallel processing cycle, and the hardware utilization of the computation module 110 is increased from approximately 25% to approximately 100%; and (iii) through the hardware-level generation mechanism, the number of hardware instructions received by the neural network acceleration processor 100 is reduced from 32 to 1, and a sequence of 32 micro-instructions is automatically generated by the decoding module 130 from the single hardware instruction. In at least one exemplary embodiment, the reduction in the number of hardware instructions from 32 to 1 and the increase in the hardware utilization of the computation module 110 from approximately 25% to approximately 100% cause the image processing chip 800 to complete the convolution-plus-bias operation with fewer instruction-fetch cycles and a higher number of image frames processed per unit time.

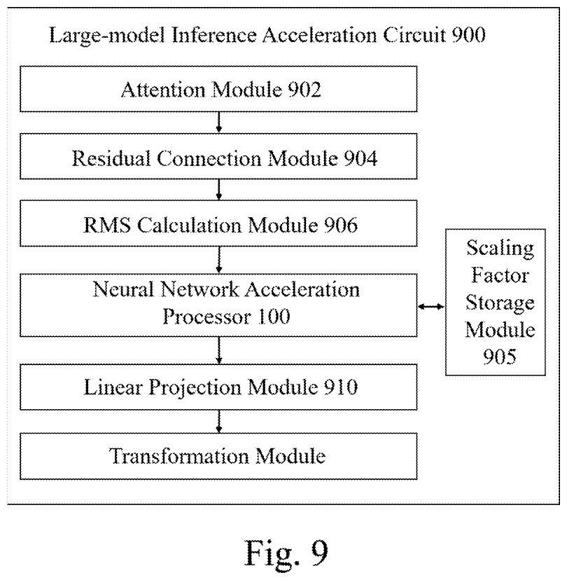

FIG. 9 illustrates a block diagram of an example deployment of the apparatus within a large-model inference acceleration circuit for Root-Mean-Square normalization operations according to additional embodiments of the present disclosure.

In some exemplary embodiments, the neural network acceleration processor 100 is deployed within a large-model inference acceleration circuit 900. The large-model inference acceleration circuit 900 includes at least one of a neural network processing unit (NPU), a graphics processing unit configured for neural network inference, a tensor processing circuit, or a large-model inference acceleration card connected to a host through a peripheral interface. The large-model inference acceleration circuit 900 is deployed within a server, a workstation, or a data center computing node for performing inference of a large language model. In some exemplary embodiments, the neural network acceleration processor 100 is coupled between a root-mean-square calculation module 906 and a linear projection module 910 within the large-model inference acceleration circuit 900, and constitutes a stage of an inference pipeline of the large-model inference acceleration circuit 900.

In some exemplary embodiments, the large-model inference acceleration circuit 900 includes an attention module 902, a residual connection module 904, the root-mean-square calculation module 906, the neural network acceleration processor 100, and the linear projection module 910. The attention module 902 performs a multi-head self-attention operation on an input hidden-state vector of a current layer of the large language model and generates an attention output vector. The residual connection module 904 performs an element-wise addition between the attention output vector and the input hidden-state vector and generates a residual hidden-state vector.

The large-model inference acceleration circuit 900 further comprises a scaling factor storage module 905 communicatively coupled to the data I/O module 103 of the neural network acceleration processor 100. The scaling factor storage module 905 is configured to store the learnable scaling factor vector and to provide the learnable scaling factor vector to the data I/O module 103. The scaling factor storage module 905 stores the learnable scaling factor vector used by the root-mean-square normalization operation of the current layer of the large language model. The scaling factor storage module 905 may be implemented by an on-chip memory circuit or an off-chip memory circuit, including without limitation at least one of a static random-access memory (SRAM), an embedded dynamic random-access memory (eDRAM), a register file, a high-bandwidth memory (HBM), a dynamic random-access memory (DRAM), or a memristor-based memory. In some exemplary embodiments, the scaling factor storage module 905 stores respective learnable scaling factor vectors for a plurality of layers of the large language model.

In some exemplary embodiments, the root-mean-square calculation module 906 receives the residual hidden-state vector from the residual connection module 904, calculates a root-mean-square value of the residual hidden-state vector, divides each element of the residual hidden-state vector by the root-mean-square value, and generates a normalized hidden-state vector as a first vector.

In some exemplary embodiments, the data I/O module 103 of the neural network acceleration processor 100 receives the first vector from the root-mean-square calculation module 906, and receives a learnable scaling factor vector from the scaling factor storage module 905 as a second vector, where a count of second elements of the scaling factor vector equals a hidden dimension of the current layer of the large language model. Because a count of first elements of the first vector is greater than the count of the reference elements of the computation module 110 and the count of the second elements of the scaling factor vector is not greater than the count of the reference elements, the first vector constitutes a longer vector that is divided into a plurality of first segments, and the scaling factor vector constitutes a shorter vector.

In some exemplary embodiments, the data I/O module 103 loads the second elements of the scaling factor vector one time, and the data adjustment module 105 retains a copy of the scaling factor vector within the data adjustment module 105 until the computation module 110 completes the operations on all of the plurality of first segments. For each first segment of the plurality of first segments, the data adjustment module 105 cyclically retrieves the second elements from the retained copy of the scaling factor vector and pairs the cyclically retrieved second elements with the first segment. The computation module 110 performs an element-wise multiplication operation between each first segment and the cyclically retrieved second elements of the scaling factor vector, and generates an output vector of the root-mean-square normalization operation.

In some exemplary embodiments, the neural network acceleration processor 100 transmits the output vector of the root-mean-square normalization operation to the linear projection module 910, thereby causing the linear projection module 910 to perform a linear projection operation on a next layer of the large language model based on the output vector of the root-mean-square normalization operation, and generate an input vector of the next layer of the large language model.

For example, in a scenario where the large language model is a Transformer-type large language model with a hidden dimension equal to 4096, an input sequence length of the large language model is 2048, and the count of the reference elements is 128, the total count of the first elements of the first vector across all positions of the input sequence equals 4096×2048=8,388,608, the first vector is divided into 8,388,608/128=65,536 first segments, and the scaling factor vector includes 4096 second elements. In some conventional approaches, to complete the root-mean-square normalization operation, a software compiler generates 65,536 separate conventional instructions, and the scaling factor vector is re-loaded from the memory 101 2,048 times. In some exemplary embodiments of the present disclosure, by contrast, the number of hardware instructions received by the neural network acceleration processor 100 is reduced from 65,536 to 1, the sequence of 65,536 micro-instructions is automatically generated by the decoding module 130 from the single hardware instruction, the scaling factor vector is loaded only once into the data adjustment module 105, and the total number of times the scaling factor vector is loaded from the memory 101 is reduced from 2,048 to 1. In at least one exemplary embodiment, the deployment within the large-model inference acceleration circuit 900 may be applicable to scenarios in which the server, the workstation, or the data center computing node performs a token-by-token autoregressive decoding task of the large language model. In at least one exemplary embodiment, the reduction in the number of hardware instructions received by the neural network acceleration processor 100 from 65,536 to 1 and the reduction in the number of times the scaling factor vector is loaded from the memory 101 cause the large-model inference acceleration circuit 900 to generate a higher number of tokens of the large language model per unit time.

In some exemplary embodiments, the embodiments described above provide at least the following concrete improvements to the functioning of the computer system.

A reduction in the number of hardware instructions received by the instruction obtaining module 132. In a scenario where a first vector is divided into N first segments, the number of hardware instructions received by the instruction obtaining module 132 from the instruction storage device 134 is reduced from N to 1. This reduction may reduce the total number of accesses by the instruction obtaining module 132 to the instruction storage device 134, and may reduce the waiting delay of the hardware instructions in the instruction queue 122.

A reduction in the number of accesses by the data I/O module 103 to the memory 101. In a scenario where a second vector constitutes a shorter vector, the second vector is loaded one time into the data buffer unit 107 and retained within the data buffer unit 107 for cyclic retrieval, and the total number of times the second elements of the second vector are loaded from the memory 101 is reduced from N to 1. This reduction may reduce the total volume of data transfer between the neural network acceleration processor 100 and the memory 101, and may reduce the energy consumed by the data transfer during the performance of the operations.

An increase in the hardware utilization of the computation module 110. In a scenario where the count of the second elements of the second vector is substantially smaller than the count of the reference elements, and the data buffer unit 107 replicates the second vector within the data buffer unit 107 and concatenates the replicated second vectors within the data buffer unit 107 into an extended second vector having a count of elements reaching the count of the reference elements, the hardware utilization of the computation module 110 within a single parallel processing cycle is increased from approximately (a ratio of the count of the second elements of the second vector to the count of the reference elements) to approximately 100%. This increase may cause the processing width of the computation module 110 during the performance of the operations to be utilized closer to a physical processing capacity of the computation module 110.

In some exemplary embodiments, the operations performed by the computation module 110 between the elements of the extended second vector and the elements of the first segment occur concurrently across the plurality of parallel processing lanes within a single processing cycle of the computation module 110. For example, in a scenario where the count of the reference elements is 128, the computation module 110 performs 128 of the operations concurrently within the single processing cycle, and a result of the 128 operations is generated within the single processing cycle. The generation of the sequence of the plurality of micro-instructions from the single hardware instruction is performed by the decoding module 130 within an instruction decoding stage of the neural network acceleration processor 100, at a rate of a clock of the neural network acceleration processor 100.

In some exemplary embodiments, in the conventional approaches, the shorter vector is re-loaded from the memory 101 prior to each of the operations, the shorter vector is padded with zero values to align with the processing width of the computation module 110, and a separate instruction is issued for each segment of the longer vector. In the embodiments of the present disclosure, by contrast, the shorter vector is loaded one time and retained within the data buffer unit 107 for cyclic retrieval without being padded with zero values, the shorter vector is replicated within the data buffer unit 107 and concatenated within the data buffer unit 107 into the extended second vector, and the plurality of micro-instructions corresponding to the plurality of segments of the longer vector are generated by the decoding module 130 from the single hardware instruction. The retention of the shorter vector within the data buffer unit 107 for cyclic retrieval without zero-padding, the replication and concatenation of the shorter vector within the data buffer unit 107, and the generation of the plurality of micro-instructions from the single hardware instruction in combination constitute an arrangement of the modules of the neural network acceleration processor 100 that differs from the conventional approaches.

In some exemplary embodiments, the concrete improvements to the functioning of the computer system described above are not achieved through an algorithmic substitution of the operation itself. The mathematical definition of the operation, such as the addition operation or the multiplication operation, remains the same in the conventional approaches and in the embodiments of the present disclosure. The concrete improvements are achieved through the following configurations of the modules of the neural network acceleration processor 100: a configuration of the data buffer unit 107 such that, after the shorter vector is loaded one time and before the computation module 110 completes the operations on all of the segments of the longer vector, the data buffer unit 107 retains a copy of the shorter vector within the data buffer unit 107; a configuration of the data buffer unit 107 such that, in a scenario where the count of the elements of the shorter vector is substantially smaller than the count of the reference elements, the data buffer unit 107 replicates the shorter vector within the data buffer unit 107 and concatenates the replicated shorter vector within the data buffer unit 107 into the extended second vector; and a configuration of the decoding module 130 such that, based on the fields of the single hardware instruction, the decoding module 130 automatically generates a sequence of multiple micro-instructions.

In some exemplary embodiments, the embodiments described above may be implemented in any subset combination thereof. In some exemplary embodiments, the image processing chip 800 simultaneously implements all or any subset of the cyclic reuse mechanism, the replication-extension mechanism, and the hardware-level mechanism for generating multiple micro-instructions from a single hardware instruction. In some exemplary embodiments, the large-model inference acceleration circuit 900 simultaneously implements all or any subset of the cyclic reuse mechanism, the replication-extension mechanism, and the hardware-level mechanism for generating multiple micro-instructions from a single hardware instruction.

In some exemplary embodiments, any module or component within the image processing chip 800 and the large-model inference acceleration circuit 900, including without limitation the data buffer unit 107, the convolution module 802, the convolution output buffer 804, the activation function module 808, the pooling module 810, the attention module 902, the residual connection module 904, the root-mean-square calculation module 906, and the linear projection module 910, may be implemented by a hardware circuit including without limitation an application specific integrated circuit (ASIC), a coarse-grained reconfigurable architecture (CGRA), a field-programmable gate array (FPGA), an analog circuit, a memristor-based circuit, a hardware accelerator circuit within a system-on-chip (SoC), or any combination of the foregoing hardware circuits. In some exemplary embodiments, the hardware circuit may be located on a same integrated circuit die as the neural network acceleration processor 100, or located on a different integrated circuit die and communicatively coupled to the neural network acceleration processor 100 through an on-chip interconnect, an inter-die interconnect, or a peripheral interface.

In some exemplary embodiments, the convolution module 802 is implemented by a convolution circuit including a multiply-accumulate array, a systolic array, or a reconfigurable datapath. In some exemplary embodiments, the convolution output buffer 804 is implemented by an on-chip memory circuit including at least one of a static random-access memory (SRAM), an embedded dynamic random-access memory (eDRAM), a register file, or a scratchpad memory. In some exemplary embodiments, the activation function module 808 is implemented by an activation function circuit including at least one of a lookup table circuit for evaluating a non-linear activation function, a piecewise linear approximation circuit, or a dedicated arithmetic circuit, the non-linear activation function including at least one of ReLU, Sigmoid, Tanh, GELU, or SiLU. In some exemplary embodiments, the pooling module 810 is implemented by a pooling circuit including at least one of a comparator tree circuit for performing a max-pooling operation, an adder and divider circuit for performing an average-pooling operation, or a reconfigurable circuit for performing an adaptive pooling. In some exemplary embodiments, the attention module 902 is implemented by an attention circuit including a matrix multiplication circuit for performing query-key-value matrix multiplications, an exponentiation and normalization circuit for performing a softmax operation, and a parallel computation array for multi-head parallel processing. In some exemplary embodiments, the residual connection module 904 is implemented by an element-wise addition circuit. In some exemplary embodiments, the root-mean-square calculation module 906 is implemented by a root-mean-square calculation circuit including a squaring circuit for performing a squaring operation, an accumulation circuit for performing a summation operation, a reciprocal square root circuit for performing a reciprocal square root operation, and a division circuit for performing a division operation. In some exemplary embodiments, the linear projection module 910 is implemented by a matrix multiplication circuit including at least one of a systolic array, a vector multiply-accumulate array, or a tensor processing engine.

What is claimed is:

1. An apparatus for neural network processing, comprising:
a computation module having a processing width corresponding to a count of reference elements, the count of the reference elements being a maximum count of elements that the computation module is capable of processing in a single processing cycle;
a data input/output (I/O) module configured to receive, from a memory, a first vector and a second vector, wherein the first vector is longer than the second vector, the first vector is divided into a plurality of first segments, and each of the plurality of first segments comprises a count of elements that is not greater than the count of the reference elements;
a data buffer unit configured to:
receive the second vector from the data I/O module, and
retain the second vector within the data buffer unit until the computation module completes operations on all of the plurality of first segments, such that the data I/O module is configured to load the second vector from the memory a single time for the plurality of first segments; and
a data adjustment module configured to, for each of the plurality of first segments:
cyclically retrieve a plurality of elements from the second vector retained in the data buffer unit,
pair the plurality of elements that have been cyclically retrieved with the first segment, and
transmit the first segment paired with the plurality of elements to the computation module to perform the operations.

2. The apparatus of claim 1, wherein cyclically retrieving the plurality of elements from the second vector retained in the data buffer unit comprises: sequentially reading elements from a start of the second vector toward an end of the second vector, and upon reaching the end of the second vector, continuing to sequentially read elements from the start of the second vector, until a count of the plurality of elements that have been cyclically retrieved is equal to the count of the elements of the first segment.

3. The apparatus of claim 1, wherein the data buffer unit is implemented as an independent unit within a data module of the apparatus, the data buffer unit being separate from the data adjustment module and coexisting with the data adjustment module within the data module.

4. The apparatus of claim 1, wherein the data buffer unit is integrated within the data adjustment module as an internal portion of the data adjustment module.

5. The apparatus of claim 1, wherein the data buffer unit is implemented by an on-chip memory circuit located on a same integrated circuit die as the computation module, the on-chip memory circuit comprising at least one of a static random-access memory, an embedded dynamic random-access memory, a register file, a scratchpad memory, a three-dimensional dynamic random-access memory, a memristor-based memory, or a non-volatile memory.

6. The apparatus of claim 1, wherein the plurality of elements is cyclically retrieved from the second vector retained in the data buffer unit without padding the second vector with zero values.

7. The apparatus of claim 1, wherein, when a count of elements of the second vector is less than a threshold percent of the count of the reference elements:
the data buffer unit is further configured to:
replicate the second vector at least one time within the data buffer unit, and
concatenate the second vector and the second vector that has been replicated at least one time within the data buffer unit into an extended second vector, a count of elements of the extended second vector being not greater than the count of the reference elements;
the data adjustment module is further configured to:
retrieve the extended second vector from the data buffer unit,
pair the extended second vector with each first segment of the plurality of first segments, and
transmit each first segment paired with the extended second vector to the computation module; and
the computation module is further configured to perform, within a single parallel processing cycle, the operations between all of the elements of the extended second vector and all of the elements of each first segment of the plurality of first segments in parallel.

8. The apparatus of claim 7, wherein the threshold percent is one of fifty percent, sixty percent, seventy percent, eighty percent, or ninety percent.

9. The apparatus of claim 1, further comprising:
an instruction storage device configured to store a single hardware instruction, the single hardware instruction comprising a short-vector identifier field that identifies which one of the first vector and the second vector is to be processed as the shorter vector;
an instruction obtaining module configured to receive the single hardware instruction from the instruction storage device; and
a decoding module configured to:
parse the short-vector identifier field, a length field of the first vector, and a length field of the second vector of the single hardware instruction, and
automatically generate, from the single hardware instruction, a sequence of a plurality of micro-instructions based on a result of the parsing, each micro-instruction of the sequence corresponding to one of the operations performed by the computation module on one pair of paired segments.

10. The apparatus of claim 9, wherein the computation module comprises a plurality of parallel processing lanes physically arranged in the computation module, the count of the reference elements being equal to a count of the plurality of parallel processing lanes physically arranged in the computation module; and
wherein the decoding module is further configured to, during an instruction decoding stage and prior to dispatching any micro-instruction to the computation module, compare the length field of the first vector and the length field of the second vector against the count of the plurality of parallel processing lanes of the computation module to automatically determine a segmentation manner.

11. The apparatus of claim 1, wherein the computation module comprises at least one of an addition processor, a subtraction processor, a logical conjunction processor, or a dot product processor.

12. The apparatus of claim 1, wherein each element of the first vector and each element of the second vector is a value represented in a predetermined number of bits.

13. An image processing chip, comprising:
a convolution module configured to perform a convolution operation on an input feature map to generate a convolution output result;
a convolution output buffer configured to temporarily store the convolution output result in a form of a first vector;
a bias parameter storage module configured to store a bias vector;
a neural network acceleration processor communicatively coupled to the convolution output buffer and to the bias parameter storage module, the neural network acceleration processor comprising a computation module, a data input/output (I/O) module, and a data buffer unit, the computation module having a processing width corresponding to a count of reference elements;
an activation function module communicatively coupled to the neural network acceleration processor; and
a pooling module communicatively coupled to the activation function module;
wherein the neural network acceleration processor is coupled between the convolution output buffer and the activation function module, and the neural network acceleration processor constitutes a stage of an inference pipeline of the image processing chip;
wherein the data I/O module is configured to receive the first vector from the convolution output buffer and receive, from a bias parameter storage module, the bias vector as a second vector, a count of elements of the bias vector being equal to a count of output channels of the convolution operation;
wherein the data buffer unit is configured to:
receive the bias vector from the data I/O module, and
retain the bias vector within the data buffer unit until the computation module completes element-wise addition operations on all of a plurality of first segments into which the first vector is divided, such that the data I/O module loads the bias vector from a memory a single time for the plurality of first segments;
wherein the computation module is configured to, for each of the plurality of first segments, perform one of the element-wise addition operations between the first segment and a plurality of elements cyclically retrieved from the bias vector retained in the data buffer unit to generate a biased intermediate result; and
wherein the neural network acceleration processor is configured to transmit the biased intermediate result to the activation function module to cause the activation function module to perform a non-linear activation operation on the biased intermediate result to generate an activated result, and to cause the pooling module to perform a pooling operation on the activated result to generate an output of the image processing chip.

14. The image processing chip of claim 13, wherein, when the count of the elements of the bias vector is less than a threshold percent of the count of the reference elements:
the data buffer unit is further configured to:
replicate the bias vector at least one time within the data buffer unit, and
concatenate the bias vector and the bias vector that has been replicated at least one time within the data buffer unit into an extended bias vector, a count of elements of the extended bias vector being not greater than the count of the reference elements; and
the computation module is further configured to perform, within a single parallel processing cycle and for each first segment of the plurality of first segments, the element-wise addition operations between all of the elements of the extended bias vector and all of the elements of the first segment in parallel.

15. The image processing chip of claim 13, further comprising:
an instruction storage device configured to store a single hardware instruction;
an instruction obtaining module configured to receive the single hardware instruction from the instruction storage device; and
a decoding module configured to automatically generate, from the single hardware instruction, a sequence of a plurality of micro-instructions, each micro-instruction of the sequence corresponding to one of the element-wise addition operations performed by the computation module between one first segment of the plurality of first segments and the bias vector.

16. The image processing chip of claim 13, wherein:
the image processing chip comprises at least one of an image signal processor, a neural network processing unit, a vision processing unit, or a neural network acceleration card; and
the image processing chip is deployed within an imaging device.

17. A large-model inference acceleration circuit, comprising:
an attention module configured to perform a multi-head self-attention operation on an input hidden-state vector of a current layer of a large language model to generate an attention output vector;
a residual connection module configured to perform an element-wise addition between the attention output vector and the input hidden-state vector to generate a residual hidden-state vector;
a root-mean-square calculation module configured to perform a root-mean-square calculation portion of a root-mean-square normalization on the residual hidden-state vector to generate a normalized hidden-state vector as a first vector;
a scaling factor storage module configured to store a learnable scaling factor vector;
a neural network acceleration processor communicatively coupled to the root-mean-square calculation module and the scaling factor storage module, the neural network acceleration processor comprising a computation module, a data input/output (I/O) module, and a data buffer unit, the computation module having a processing width corresponding to a count of reference elements; and
a linear projection module communicatively coupled to the neural network acceleration processor;
wherein the neural network acceleration processor is coupled between the root-mean-square calculation module and the linear projection module, and the neural network acceleration processor constitutes a stage of an inference pipeline of the large-model inference acceleration circuit;
wherein the data I/O module is configured to receive the first vector from the root-mean-square calculation module and receive, from a scaling factor storage module, the learnable scaling factor vector as a second vector, a count of elements of the learnable scaling factor vector being equal to a hidden dimension of the current layer of the large language model;
wherein the data buffer unit is configured to:
receive the learnable scaling factor vector from the data I/O module, and
retain the bias vector within the data buffer unit until the computation module completes element-wise addition operations on all of a plurality of first segments into which the first vector is divided, such that the data I/O module loads the bias vector from a memory a single time for the plurality of first segments;
wherein the computation module is configured to, for each first segment of the plurality of first segments, perform one of the element-wise multiplication operations between the first segment and a plurality of elements cyclically retrieved from the learnable scaling factor vector retained in the data buffer unit to complete a scaling portion of the root-mean-square normalization to generate an output vector of the root-mean-square normalization; and
wherein the neural network acceleration processor is configured to transmit the output vector of the root-mean-square normalization to the linear projection module to cause the linear projection module to perform a linear projection operation on a next layer of the large language model based on the output vector of the root-mean-square normalization.

18. The large-model inference acceleration circuit of claim 17, further comprising:
an instruction storage device configured to store a single hardware instruction;
an instruction obtaining module configured to receive the single hardware instruction from the instruction storage device; and
a decoding module configured to automatically generate, from the single hardware instruction, a sequence of a plurality of micro-instructions, each micro-instruction of the sequence corresponding to one of the element-wise multiplication operations performed by the computation module between one first segment of the plurality of first segments and the learnable scaling factor vector.

19. The large-model inference acceleration circuit of claim 17, wherein:
the large-model inference acceleration circuit comprises at least one of a neural network processing unit, a graphics processing unit configured for neural network inference, a tensor processing circuit, or a large-model inference acceleration card connected to a host through a peripheral interface.

20. The large-model inference acceleration circuit of claim 17, wherein the large-model inference acceleration circuit is configured to perform a token-by-token autoregressive decoding task of the large language model.
